(19) United States
(12) Patent Application Publication
(10) Pub. No.: US 2019/0283046 A1
(43) Pub. Date: Sep. 19, 2019

(54) WET CYCLONE APPARATUS

(71) Applicant: KOREA INSTITUTE OF SCIENCE AND TECHNOLOGY, Seoul (KR)

(72) Inventors: Jae Hee JUNG, Seoul (KR); Byoung Chan KIM, Seoul (KR); Seung Bok LEE, Seoul (KR); Kang Bong LEE, Seoul (KR); Yusung CHO, Seoul (KR)

(21) Appl. No.: 16/281,097

(22) Filed: Feb. 21, 2019

(30) Foreign Application Priority Data
Mar. 15, 2018 (KR) 10-2018-0030140

(51) Int. Cl. B04C 9/00; B04C 11/00; B04C 5/185; B04C 5/08; B01D 45/16; B01D 47/00; B01D 50/00; G01N 1/22

(52) U.S. Cl. CPC B04C 9/00; B04C 11/00; B04C 5/185; B04C 5/08; B04C 2009/008; B01D 47/00; B01D 50/004; G01N 1/2211; B01D 45/16

(57) ABSTRACT

Provided is a wet cyclone apparatus including a body, an inlet installed in the body, and having a passage through which air including airborne particles is sucked in, a wet cyclone connected to the inlet to wet and collect the airborne particles introduced from the inlet, and a water storage installed in the body to store water, wherein the wet cyclone includes an air suction port into which the air introduced from the inlet is sucked, a water inlet through which water is supplied from the water storage, and a sample outlet through which the collected wetted sample is extracted and discharged.

### DESCRIPTION OF GOVERNMENT-SPONSORED RESEARCH AND DEVELOPMENT

This research is made in line with the environmental policy based public technology development project (No. 1485014814, Development of technology for real-time in situ detection of bioaerosols and hazardous substances in ultrafine dust and fine dust) in Korea Environmental Industry & Technology Institute, Ministry of Environment in Republic of Korea under the supervision of Korea Institute of Science and Technology.

### CROSS-REFERENCE TO RELATED APPLICATION

This application claims priority to Korean Patent Application No. 10-2018-0030140, filed on Mar. 15, 2018, and all the benefits accruing therefrom under 35 U.S.C. § 119, the contents of which in its entirety are herein incorporated by reference.

### BACKGROUND

### 1. Field

The present disclosure relates to a wet cyclone apparatus, and more particularly, to a wet cyclone apparatus for real-time wet collection of fine dust and airborne microorganisms in air.

### 2. Description of the Related Art

In relation to detection and measurement technology of fine dust and airborne microorganisms, various types of particle collectors have been developed so far. The most common particle collection method is a filter dust collection method that is similar to a general fine dust collection method, and measures and analyzes fine dust attached to the filter.

However, in this case, it may be difficult to continuously measure fine dust and airborne microorganisms in real time. Additionally, in the case of airborne microorganisms, it is difficult to maintain viability that is an important intrinsic characteristic of living microbes. Dust collection instruments developed to solve these problems, such as impingers and biosamplers, adopt a method that collects particles in liquid such as water to maximize physical particle collection efficiency while maintaining viability of airborne microorganisms to the maximum.

However, an airborne microorganism collector using this inertial attachment principle of particles is a passive apparatus that requires a researcher to operate in person on the spot, and there is a need for development of an apparatus for continuous collection and detection of airborne microorganisms.

Additionally, there is a need for development of an apparatus that achieves collection with high concentration, and improves the collection performance of fine dust and airborne microorganisms while maintaining viability of airborne microorganisms from the wet collection principle.

### SUMMARY

The present disclosure is designed to solve the above-described problem, and therefore the present disclosure is directed to providing an apparatus that wets and collects fine dust and airborne microorganisms included in air to obtain samples in real time.

A wet cyclone apparatus of the present disclosure includes a body, an inlet installed in the body, and having a passage through which air including airborne particles is sucked in, a wet cyclone connected to the inlet to wet and collect the airborne particles introduced from the inlet, and a water storage installed in the body to store water, and the wet cyclone may include an air suction port into which the air introduced from the inlet is sucked, a water inlet through which water is supplied from the water storage, and a sample outlet through which the collected wetted sample is extracted and discharged.

The wet cyclone apparatus of the present disclosure may further include a control unit which adjusts an amount of air sucked into the air suction port through the inlet, and the control unit may include a main power supply which supplies power, and a control board connected to the main power supply to receive the power, and allow a water supply pump, a sample supply pump and a sample extraction pump to operate.

The control unit may further include a condition monitoring control board which monitors and controls condition of the water supply pump, the sample supply pump and the sample extraction pump, and a power supply unit electrically connected to the condition monitoring control board to supply power to the condition monitoring control board.

The condition monitoring control board may be equipped with a wireless communication unit to remotely enable condition monitoring and control.

According to another embodiment in relation to the present disclosure, the inlet may filter out fine dust and airborne microorganism particles from coarse particles to separate and concentrate target particles.

The wet cyclone apparatus of the present disclosure may further include a sample extraction pump which provides a pumping power to extract the collected wetted samples in the wet cyclone, and a sample storage which stores the extracted samples.

Inner walls of the wet cyclone may be treated with superhydrophilic coating to improve collection performance.

In addition, the wet cyclone may be transparent to see changes at interface between gas and liquid and concentrated wetted particles with a naked eye.

Two or more water inlets may be arranged along a circumferential direction from an outer periphery of a body of the wet cyclone.

### BRIEF DESCRIPTION OF THE DRAWINGS

FIG. 1 is a perspective view showing a wet cyclone apparatus of the present disclosure.

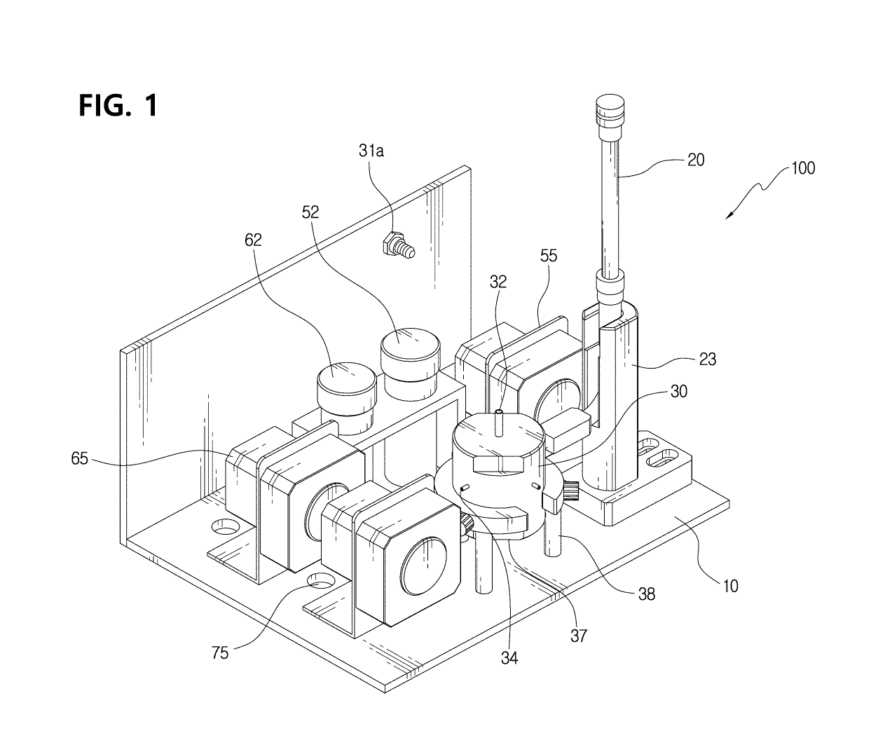

FIG. 2 is a perspective view showing a control unit of the present disclosure.

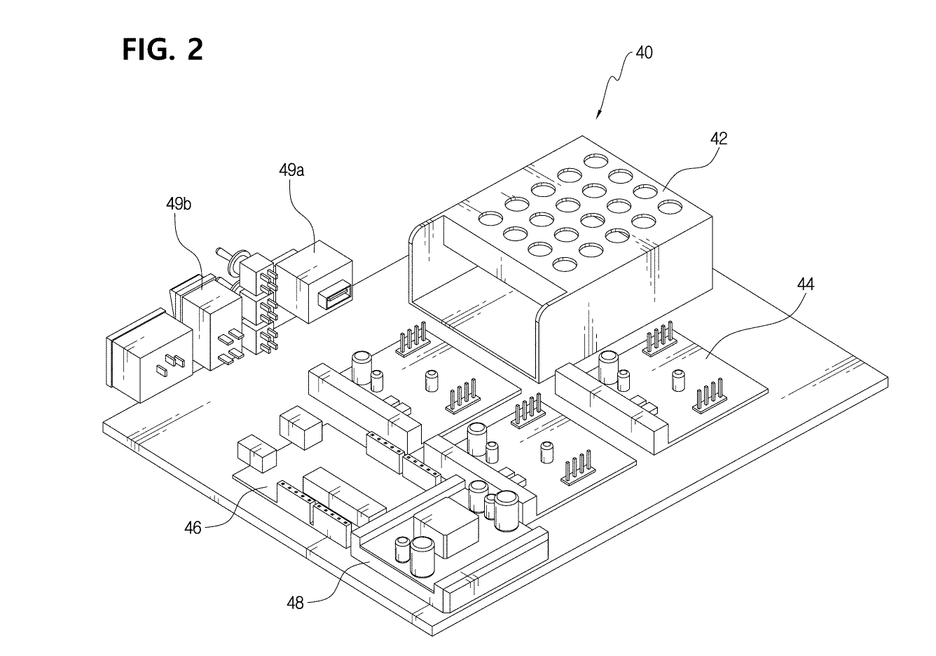

FIG. 3 is a side view showing a wet cyclone of the present disclosure.

FIG. 4 is a schematic diagram of an experiment for effectively evaluating the collection and detection performance of test particles.

FIG. 5 is a graph of a ratio of flow rates for determining a stable operation condition considering the collection performance of a wet cyclone.

FIG. 6 is a photographic image showing a contact angle with a transparent acrylic surface having a superhydrophilic coating.

FIG. 7 is a graph showing collection efficiency curves based on each air and water flow rate using reference particles.

FIG. 8 is a graph showing air-water particle transfer efficiency based on each air and water flow rate using test particles.

FIG. 9 is a graph showing a size distribution of bacteria and a scanning electron microscope (SEM) image of bacteria used in experiment.

FIG. 10 is a graph showing collection efficiency of bacteria (S. epidermidis, M. luteus).

FIG. 11 is a graph of viability after agar cultivation of collected bacteria, compared to an existing airborne microorganism sampler.

FIG. 12 is a conceptual diagram of an automated apparatus using a wet cyclone module.

FIG. 13 is a graph showing real-time performance testing for an abrupt concentration change using a wet cyclone apparatus, compared to a real-time measurement instrument Ultraviolet Aerodynamic Particle Sizer (UV-APS).

FIG. 14 is a graph showing collection performance testing of a wet cyclone apparatus for airborne fine particles changing in real time in a real outdoor environment, compared to a real-time measurement instrument Optical Particle Counter (OPC).

### DETAILED DESCRIPTION

Hereinafter, the disclosed embodiments are described in detail with reference to the accompanying drawings, in which identical or similar elements are given identical or similar reference signs, and redundant descriptions are omitted herein. As used herein, the suffix “unit” is merely added or used interchangeably in consideration of easiness of description, but by itself, having no distinct meaning or role. Additionally, in describing the disclosed embodiments, when a certain detailed description of relevant known technology is deemed to render the subject matter of the disclosed embodiments vague, the detailed description is omitted herein. Additionally, the accompanying drawings are only for the purpose of a better understanding of the disclosed embodiments, and it should be understood that the technical spirit of this disclosure is not limited by the accompanying drawings and encompasses all modifications, equivalents or substituents within the spirit and scope of the present disclosure.

The terms including the ordinal numbers such as “first”, “second”, and the like may be used to describe various elements, but the elements are not limited by the terms. These terms are only used to distinguish one element from another.

It should be further understood that when an element is referred to as being “connected to” another element, it can be directly connected to the other element or intervening elements may be present.

As used herein, the singular forms are intended to include the plural forms as well, unless the context clearly indicates otherwise.

It should be further understood that the term “comprises” or “includes” when used in this specification, specifies the presence of stated features, integers, steps, operations, elements, components or groups thereof, but does not preclude the presence or addition of one or more other features, integers, steps, operations, elements, components or groups thereof.

The wet cyclone apparatus 100 of the present disclosure includes a body 10, an inlet 20 and a wet cyclone 30.

The body 10 has the inlet 20 and the wet cyclone 30 installed therein.

Additionally, the body 10 is configured to receive various components as described below. The body 10 has a vacuum pump port 31a, and the vacuum pump port 31a sucks fine dust and airborne microorganisms in through the inlet 20 together with air.

The inlet 20 may be installed above the body 10, and has a passage through which air including airborne particles is sucked in.

The inlet 20 may filter out fine dust and airborne microorganism particles from coarse particles of a predetermined size or more to separate and concentrate target particles.

For example, the inlet 20 may be installed in the body 10 with the lower part being received by an inlet support 23.

The wet cyclone 30 is connected to the inlet 20 to wet and collect the airborne particles introduced from the inlet 20. To this end, water is supplied to the wet cyclone 30 to mix the airborne particles with the water. For example, the wet cyclone 30 may be installed in the body 10 such that the lower part is placed on a cyclone support 38.

The wet cyclone 30 includes an air suction port 31, a water inlet 34 and a sample outlet 37.

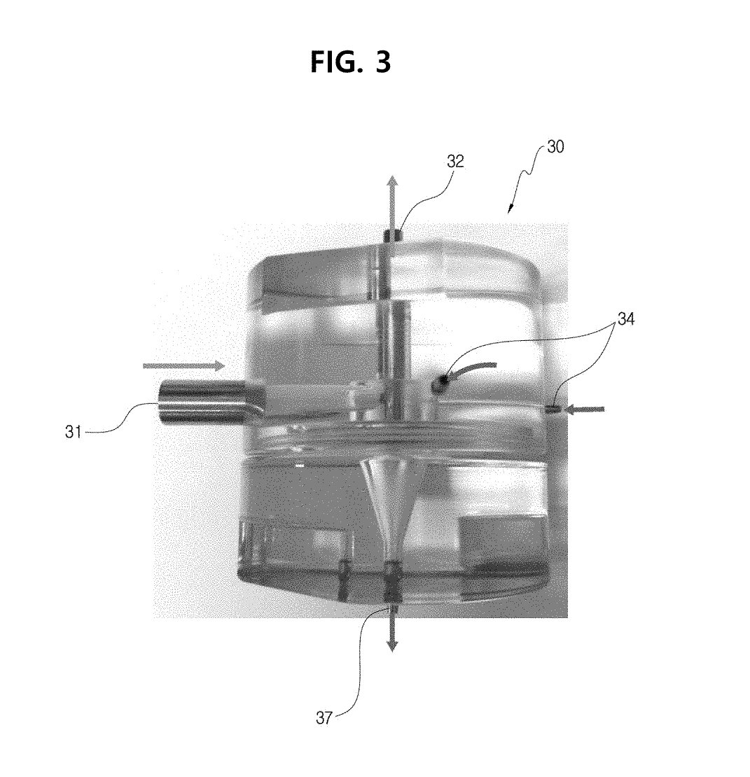

The air suction port 31 is formed to suck air introduced from the inlet 20. Referring to FIG. 3, the air suction port 31 is formed on the side of the body of the wet cyclone 30 to allow fine dust and airborne microorganisms to be seated on the cyclone inner walls. After air introduced through the air suction port 31 is mixed with water, a fraction of the air may be discharged through an air outlet 32. The air outlet 32 may be formed on the wet cyclone 30.

The water inlet 34 is connected to a water storage 52 to receive water from the water storage 52. Two or more water inlets 34 may be arranged along a circumferential direction from an outer periphery of the body of the wet cyclone 30, to uniformly form a liquid film of the collected wetted sample from the top of the inner walls of the wet cyclone 30.

The sample outlet 37 is through which the collected wetted sample is extracted and discharged. For example, the sample outlet 37 may be provided under the wet cyclone 30, and the sample outlet 37 is in communication with the sample storage 62 so that the sample in the wet cyclone 30 is continuously supplied to the sample storage 62 by a sample extraction pump 75.

The wet cyclone 30 may be treated with superhydrophilic coating on the inner walls, thereby forming a uniform liquid film on the inner walls of the wet cyclone 30 and improving the collection performance. Additionally, the wet cyclone 30 may be transparent to see changes at interface between gas and liquid and concentrated wetted particles with a naked eye.

Additionally, the wet cyclone apparatus 100 may further include the water storage 52 to store water that is continuously introduced into the wet cyclone 30, and a water supply pump 55 to provide a pumping power for continuously supplying water from the water storage 52 to the wet cyclone 30. The water supply pump 55 may be, for example, a peristaltic pump.

The wet cyclone apparatus 100 of the present disclosure may further include a control unit 40. The control unit 40 may individually control the operation of the water supply pump 55, a sample supply pump 65 and the sample extraction pump 75. Additionally, the control unit 40 is configured to adjust an amount of air sucked into the air suction port 31 through the inlet 20.

The control unit 40 may include a main power supply 42, a control board 44, a condition monitoring control board 46 and a power supply unit 48.

The main power supply 42 may supply power to the control board 44.

The control board 44 is electrically connected to the main power supply 42 to receive power. The control board 44 operates the water supply pump 55, the sample supply pump 65 and the sample extraction pump 75. The control board 44 has a main power switch 49a and a peristaltic pump switch 49a installed therein. The main power switch 49a individually applies power to each pump connected to the control board 44. Additionally, the pump switch 49a switches each of the water supply pump 55, the sample supply pump 65 and the sample extraction pump 75.

The condition monitoring control board 46 controls the condition of the water supply pump 55, the sample supply pump 65 and the sample extraction pump 75.

The condition monitoring control board 46 may have a wireless communication unit, to allow a user to remotely control the condition of the water supply pump 55, the sample supply pump 65 and the sample extraction pump 75 through wireless communication with the wireless communication unit.

The wet cyclone apparatus 100 of the present disclosure may further include the sample extraction pump 75 and the sample storage 62.

The sample extraction pump 75 provides a pumping power to extract the collected wetted samples in the wet cyclone 30. The sample extraction pump 75 may be, for example, a peristaltic pump.

The sample storage 62 is configured to store the samples extracted from the wet cyclone 30 by the sample extraction pump 75. Additionally, the sample storage 62 has the sample supply pump 65 installed therein to take out the samples stored in the sample storage 62, and the extracted samples are used for analysis.

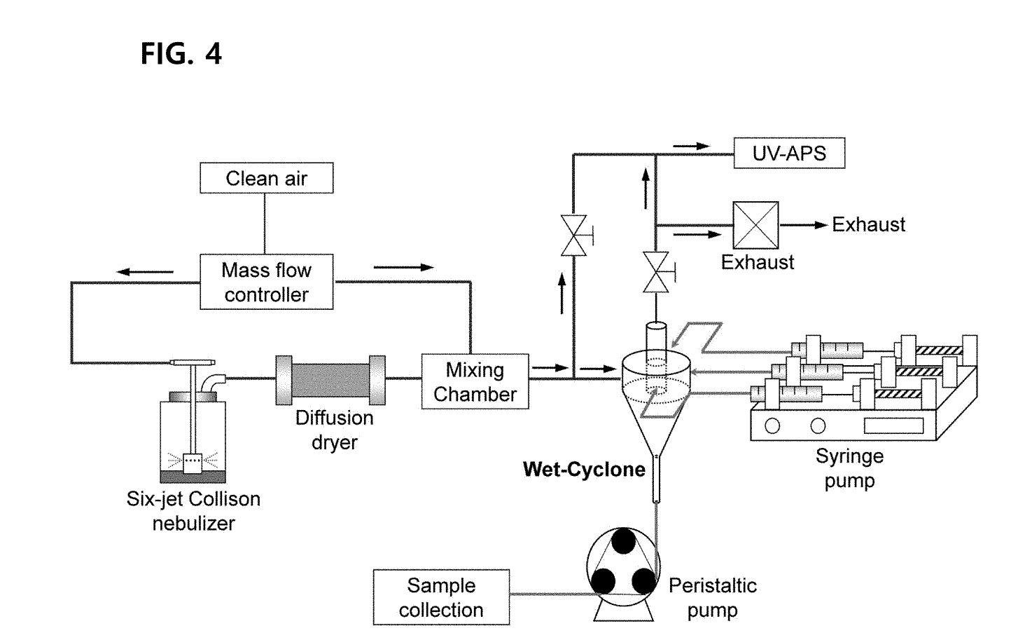

FIG. 4 is a schematic diagram of an experiment for effectively collecting and detecting test particles (bacteria) using the wet cyclone apparatus of the present disclosure.

First, test particles representing fine dust and airborne microorganisms are mixed with distilled water to place a solution in a nebulizer. In this instance, when the test particles are jetted from the nebulizer together with intake air, they are allowed to pass through a diffusion dryer to remove excess moisture from the particles within room temperature. A final air flow rate including these particles to introduce into the wet cyclone is satisfied by mixing with diluted air controlled by a flow rate controller in a mixing chamber.

A water flow rate fed into the wet cyclone is fed and adjusted by a syringe pump and a syringe. Additionally, a drainage flow rate of a water outlet for extracting samples including particles in the wet cyclone is adjusted by a peristaltic pump. Accordingly, it is possible to continuously collect and extract particles. In this instance, an air suction port and an air outlet of the wet cyclone are connected to the real-time measurement instrument Ultraviolet Aerodynamic Particle Sizer (UV-APS) and Wide-Range Particle Spectrometer (WPS) for measuring the size and concentration of the test particles to analyze the collection efficiency based on the particle diameter of the test particles.

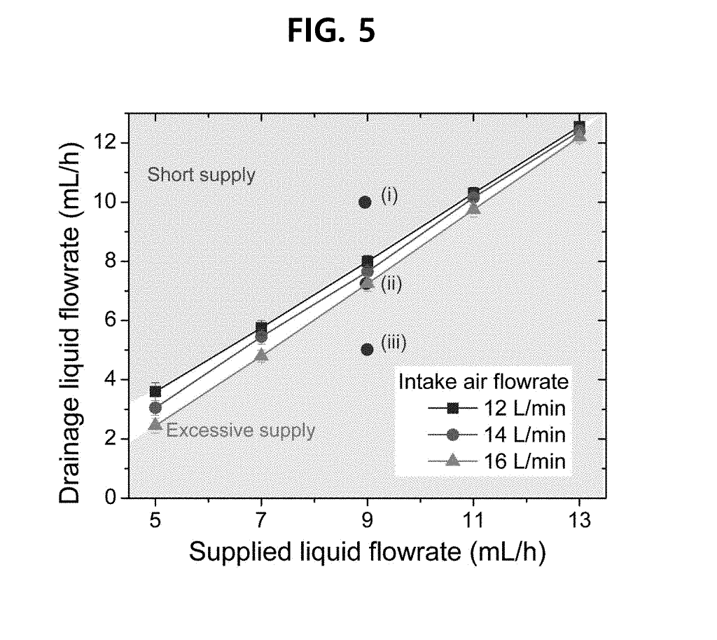

FIG. 5 is a graph satisfying a stable operation condition obtained by determining a ratio of a flow rate of water introduced with air and a drainage flow rate for extracting samples including particles based on each air flow rate. It is found that when the flow rate of water introduced is constant, with the increasing air flow rate, the drainage flow rate increases, and referring to this, it can be seen that an amount of evaporated water is smaller at a low air flow rate. Additionally, it reveals that with the increasing flow rate of water introduced, the drainage flow rate increases at a constant rate for each air flow rate. This is the most stable operation condition having a tendency to determine a constant ratio of flow rates. In this instance, the stable operation condition represents operation continuously forming equal turbulent flows without loss by evaporation of water through the air outlet. When it is outside of this ratio of flow rates, the flow becomes unstable, and finally, the collection performance is greatly affected, so it is important to maintain the stability.

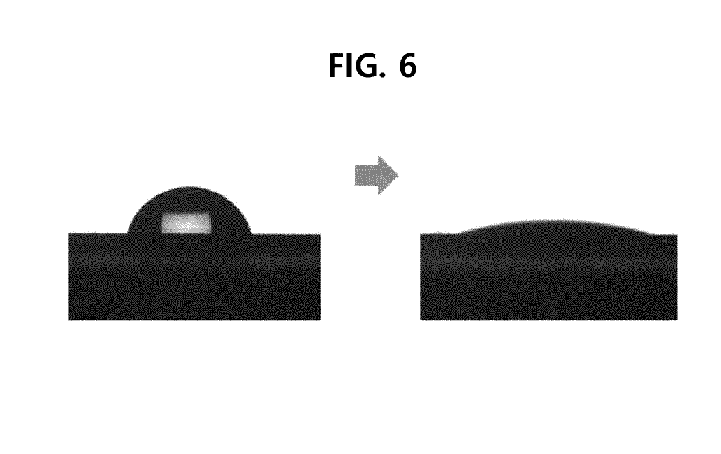

FIG. 6 shows a contact angle with a transparent acrylic surface having a superhydrophilic coating. Airborne microorganisms including fine dust entering the wet cyclone together with air (fine dust and airborne microorganisms) are collected on a liquid film by particle centrifugal forces and inertial forces. In this instance, to reduce physical impacts and minimize a particle loss, the superhydrophilic coating treatment technique is applied. Accordingly, the liquid film is formed more uniformly, and particles in air are seated on the formed liquid film more stably and then wetted and collected, thereby obtaining higher physical and biological collection efficiency.

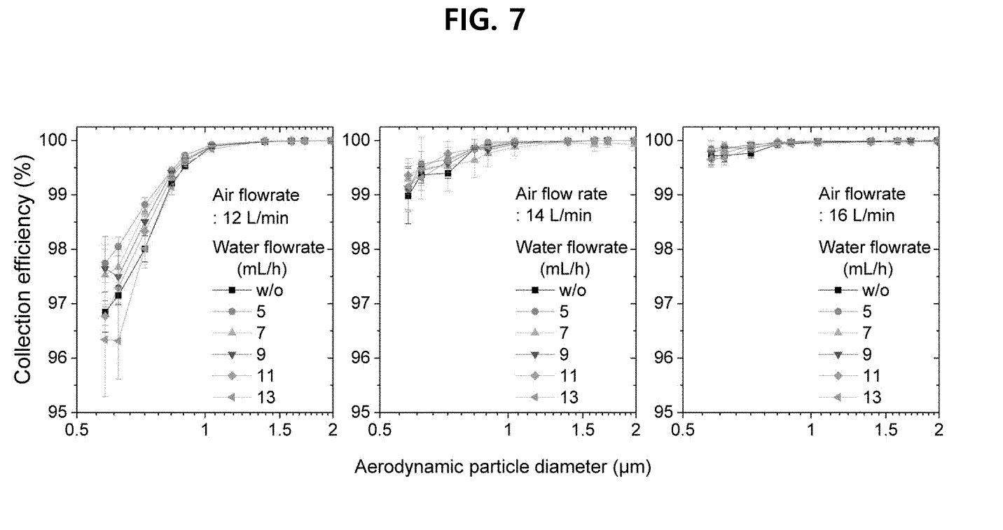

FIG. 7 is a graph showing analysis of collection efficiency based on the size of reference particles. The collection efficiency experiment for each reference particle evaluates the collection performance based on the particle diameter using particles of different sizes as test particles. As mentioned above, the experiment is conducted considering the stable operation condition for each airflow rate, and to compare the collection performance based on an amount of introduced water, a low water flow rate to a high water flow rate including no water condition are used. In this instance, it can be seen that as the flow rate of air entering the wet cyclone increases, the total collection efficiency of reference particles tends to increase, and the cut diameter also moves to the low size. However, the flow rate of introduced water does not greatly affect the collection efficiency, signifying that the ratio of flow rates is more important than the amount of introduced water.

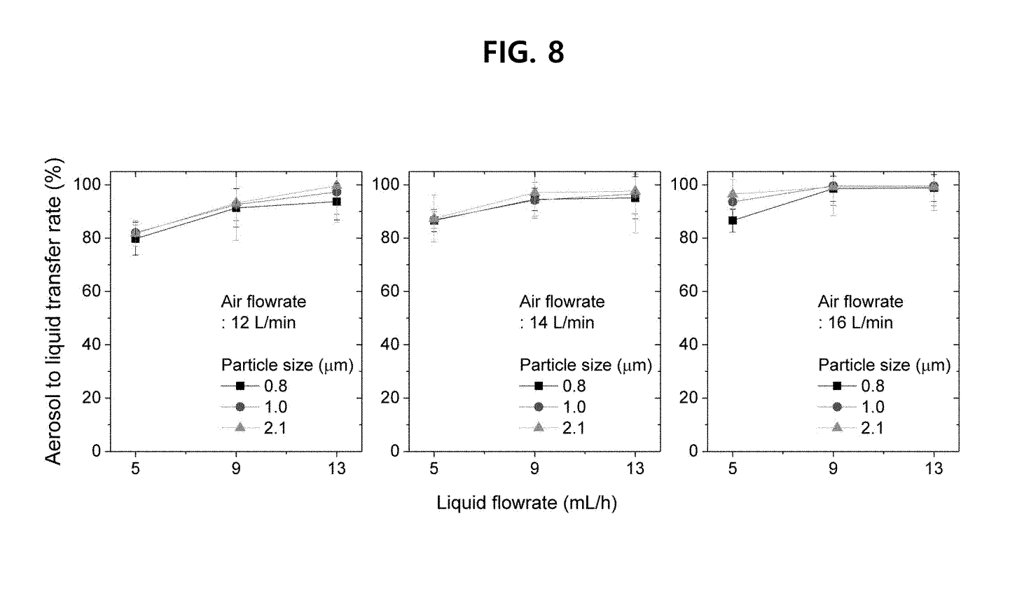

FIG. 8 is a graph showing air-water particle transfer efficiency based on each air flow rate using test particles. When fine dust and airborne microorganisms are introduced and collected in the wet cyclone, particles may be collected on the liquid film by the fed water, but particles may be collected on regions in which the liquid film is not formed, leading to a loss ratio in the total collection efficiency. Accordingly, this is referred to as transfer efficiency of particulate materials in air to the liquid film of water in the wet cyclone, namely, air-water particle transfer efficiency. As a result of comparison using test particles of different sizes, similar to the previous tendency, as the air flow rate increases, the total particle transfer efficiency tends to increase, and in this instance, when the flow rate of introduced water is highest, the highest air-water particle transfer efficiency is seen. In this instance, as particles are collected in water, a water flow rate requiring a smallest amount of water at the same efficiency is determined, considering the concentration ratio. This indicates the most optimal condition for the wet cyclone designed in the present disclosure.

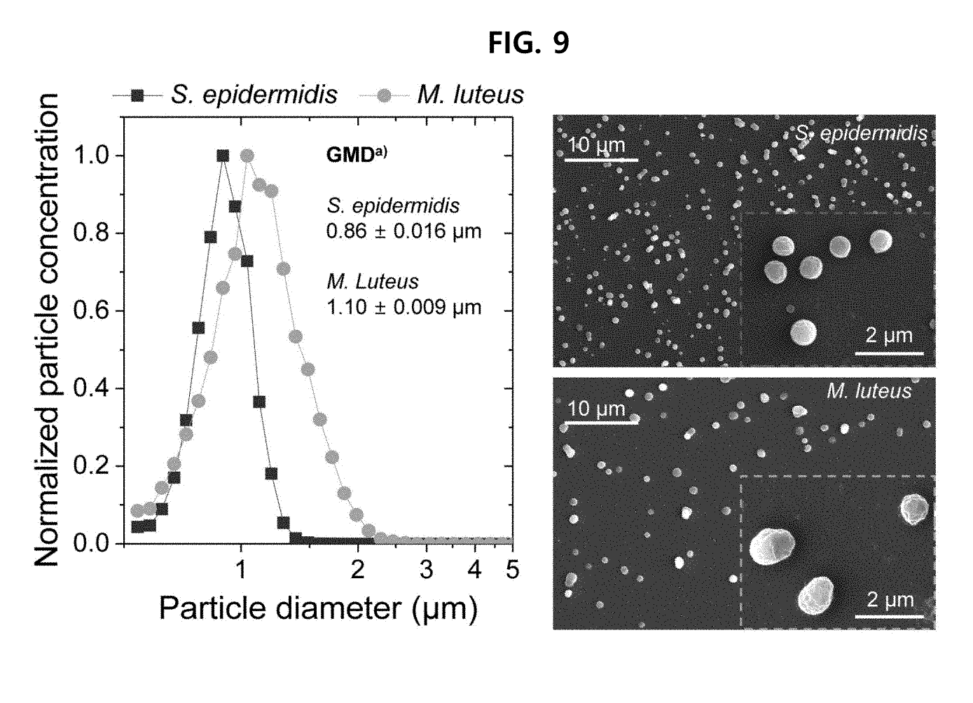

FIG. 9 shows a size distribution graph of bacteria. This shows normalized particle size and concentration information obtained by the real-time measurement instrument Ultraviolet Aerodynamic Particle Sizer (UV-APS). The next photographic image is a scanning electron microscope (SEM) image of bacteria S. epidermidis and M. luteus used in the experiment.

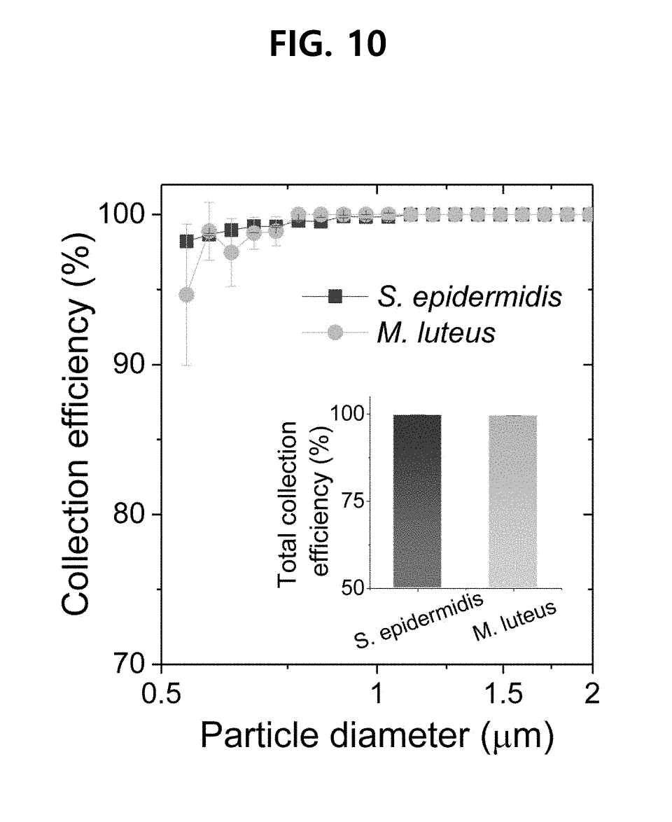

FIG. 10 shows a collection efficiency graph of bacteria (S. epidermidis, M. luteus). These are comparison values of particle concentrations obtained using the real-time measurement instrument UV-APS when particles enter and exit the wet cyclone, showing efficiency of >90% from the measurement limit value 0.5 μm of UV-APS. Accordingly, it can be seen through these two bacteria particle experiments that it is possible to collect and detect fine dust and airborne microorganisms more effectively.

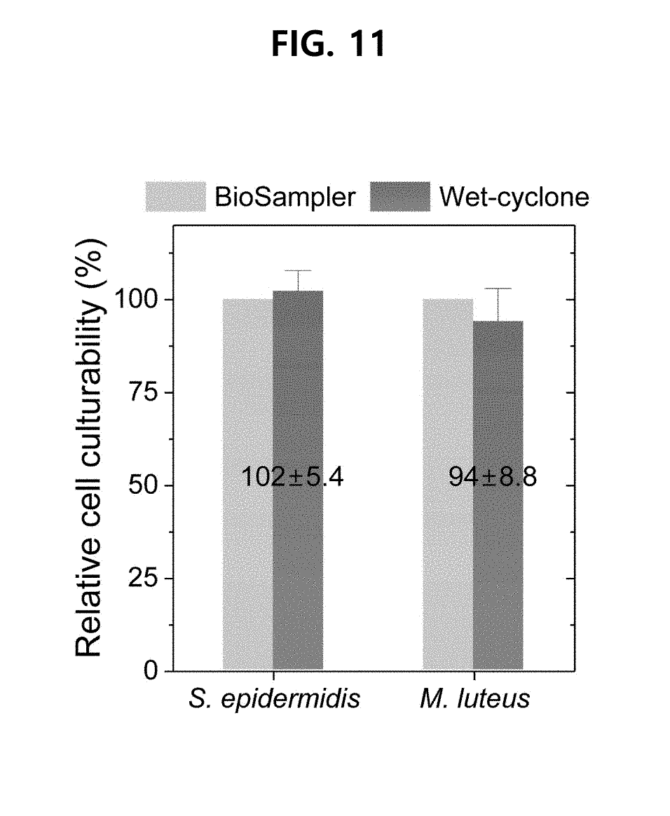

FIG. 11 is a graph of viability after agar cultivation of samples obtained by extracting bacteria (S. epidermidis, M. luteus) collected in the wet cyclone, compared to the existing airborne microorganism sampler. The existing airborne microorganism sampler is a liquid based sampler and shows a good recovery ratio, and thus it is widely used in the field of airborne microorganisms. Accordingly, on the basis of the recovery ratio of the biosampler being 100%, sampling is performed for the same time and relative viability of the wet cyclone is compared. Accordingly, in the case of S. epidermidis bacteria, the recovery ratio is found to be about 103%, and in the case of M. luteus bacteria, the recovery ratio is found to be about 92%. Advantages of the wet cyclone are that when sampling is performed for the same time, a smaller amount of water is used, achieving high concentration performance, and a recovery ratio is as high as the biosampler.

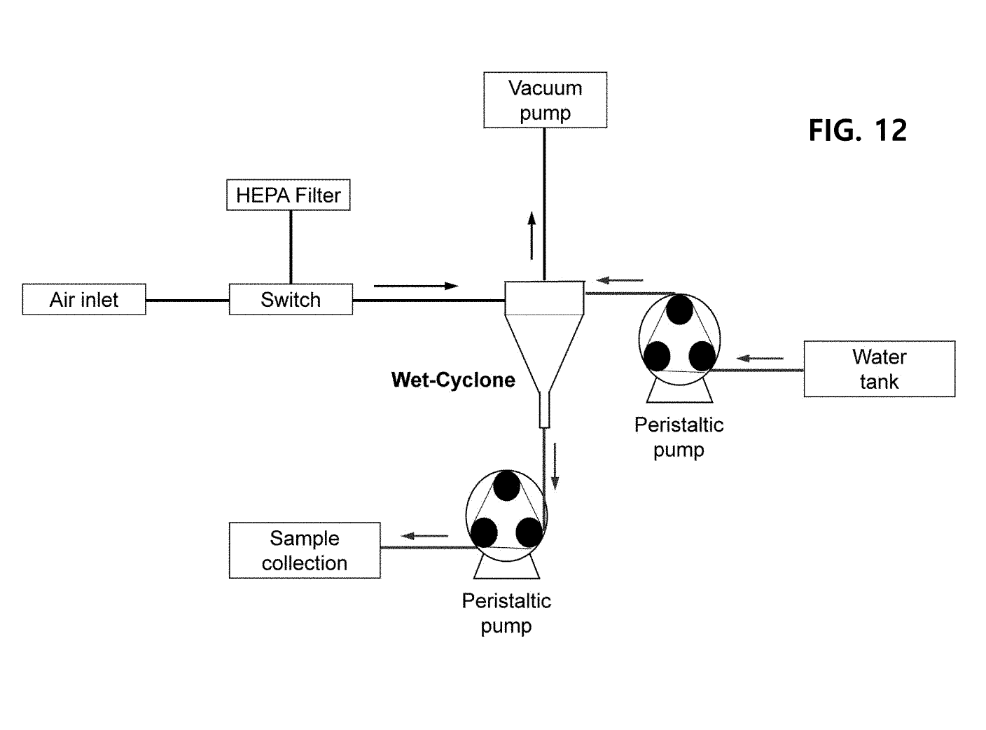

FIG. 12 is a schematic diagram of an automated apparatus using a wet cyclone module. To introduce air into the wet cyclone, a vacuum pump is used, and it is designed such that an air inlet or the like is washable. Accordingly, clean air is introduced by a high efficiency particulate air (HEPA) filter, and after washing is finished, sampling may be performed again by switching ON/OFF. Additionally, for a continuous and automated apparatus, water is continuously supplied using a peristaltic pump, and collected samples are obtained by extraction. The collected samples are separately gathered, and used by connection with various subsequent detection unit parts.

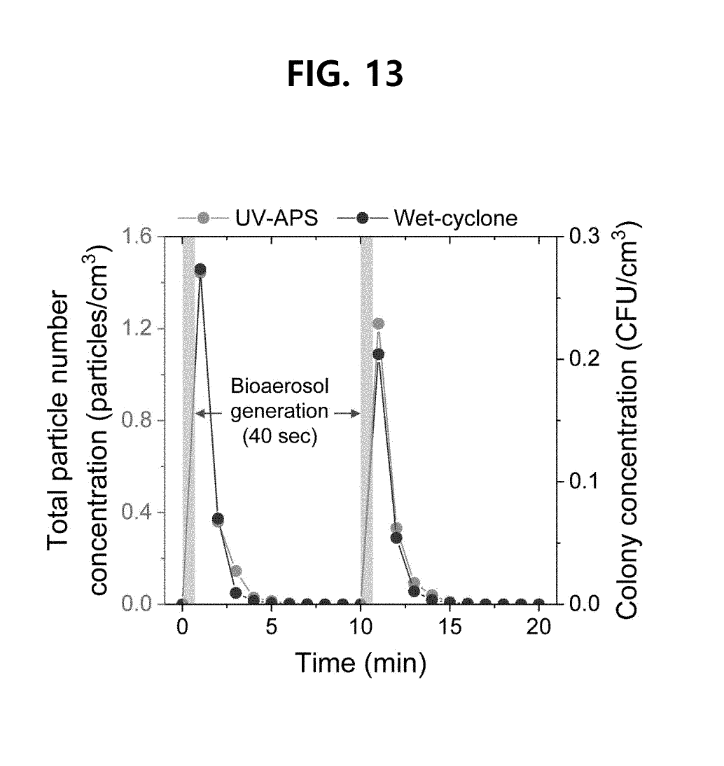

FIG. 13 shows real-time performance testing of concentration changes that may abruptly change in relation to concentration changes that frequently change in various environments using the wet cyclone apparatus, compared to the real-time measurement instrument Ultraviolet Aerodynamic Particle Sizer (UV-APS). To monitor and analyze sources of air pollution, analysis is performed by various types of collection and measurement devices, but most of them obtain average data at each time zone, making it difficult to obtain real-time data due to an abrupt concentration change. To solve this disadvantage, the real-time wet cyclone method and apparatus of the present disclosure may analyze the changing concentration at least per minute, and as a result of comparing the performance of repetitive sampling of the changing concentration within one minute to the real-time measurement instrument UV-APS, similar aspects are exhibited. This shows good performance in collection and analysis of fine particles including airborne microorganisms in air (fine particles and airborne microorganisms) changing in real time.

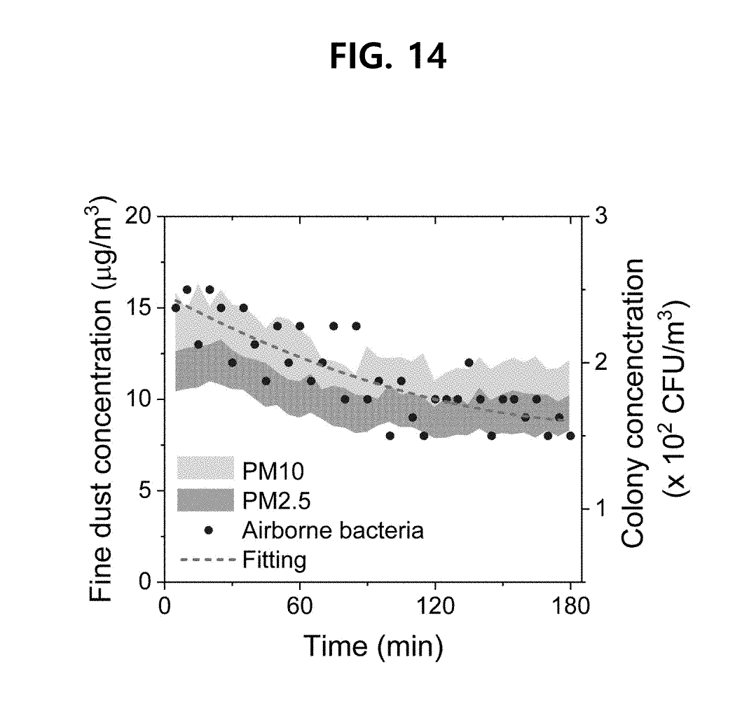

FIG. 14 shows a comparison of collection performance testing for airborne fine particles changing in real time in a real outdoor environment between the apparatus of the present disclosure having portability to use the wet cyclone apparatus in various environments and the real-time measurement instrument Optical Particle Counter (OPC). This shows that sampling may be accomplished variously according to the analysis purpose, and it may be used in various environments.

The wet cyclone apparatus of the present disclosure selects a predetermined size range of particles and concentrates airborne microorganisms including fine dust (fine dust and airborne microorganisms) using wet cyclone technology, thereby responding to changes in the concentration of contaminants in ambient air and indoor air through analysis of wetted fine dust and airborne microorganisms collected continuously in real time.

The wet cyclone apparatus of the present disclosure includes multiple water inlets of the wet cyclone to form a wider liquid film during wet collection of fine particles including airborne microorganisms (fine dust and airborne microorganisms), thereby reducing a particle loss and improving wet collection efficiency.

The wet cyclone apparatus of the present disclosure uses superhydrophilic coating technology to uniformly form the liquid film on the wet cyclone inner walls to allow fine dust and airborne microorganisms to be seated more stably, thereby maximizing wet collection efficiency.

The wet cyclone apparatus of the present disclosure automates the peristaltic pump to continuously supply water from the water storage into the wet cyclone, and extract the collected wetted sample in real time, thereby making analysis of airborne microorganisms easy.

The wet cyclone apparatus of the present disclosure includes the wet cyclone made of a transparent material to see changes at interface between the fed air and the collected liquid and concentrated wetted particles with a naked eye.

The wet cyclone apparatus of the present disclosure may achieve real-time continuous wet collection of not only airborne microorganisms but also particles of similar sizes with high collection performance.

The wet cyclone apparatus of the present disclosure may have applications with various devices for detection and analysis when attached to the rear end to allow the collected wetted sample to be transferred by the automated peristaltic pump.

The wet cyclone apparatus of the present disclosure may be combined with a thermostat to provide an optimal physical and biological collection environment irrespective of weather or season.

The wet cyclone apparatus of the present disclosure may remotely monitor and control the apparatus through a wireless communication based remote device. The highest level of concentration ratio in the world by the continuous aerosol-into-Liquid collection method is about 600,000 times as high (Texas A&M Univ., USA), and the method implemented by the wet cyclone apparatus of the present disclosure achieves the concentration ratio that is about 2,000,000 times or more as high.

The wet cyclone apparatus 100 described hereinabove is not limited to the configurations and methods of the embodiments described above, and all or some of the embodiments may be selectively combined to make various modifications.

It is obvious to those skilled in the art that the present disclosure may be embodied in any other particular form without departing from the spirit and scope of the present disclosure. Accordingly, the above detailed description should not be interpreted in a limitative manner and should be considered exemplary in all aspects. The scope of the present disclosure should be determined by the reasonable interpretation of the appended claims, and the scope of the present disclosure covers all changes made within the equivalent scope of the present disclosure.

What is claimed is:

1. A wet cyclone apparatus, comprising:
a body;
an inlet installed in the body, and having a passage through which air including airborne particles is sucked in;
a wet cyclone connected to the inlet to wet and collect the airborne particles introduced from the inlet; and
a water storage installed in the body to store water,
wherein the wet cyclone comprises:
an air suction port into which the air introduced from the inlet is sucked;
a water inlet through which water is supplied from the water storage; and
a sample outlet through which the collected wetted sample is extracted and discharged.

2. The wet cyclone apparatus according to claim 1, further comprising:
a control unit which adjusts an amount of air sucked into the air suction port through the inlet,
wherein the control unit comprises:
a main power supply which supplies power; and
a control board connected to the main power supply to receive the power, and allow a water supply pump, a sample supply pump and a sample extraction pump to operate.

3. The wet cyclone apparatus according to claim 2, wherein the control unit further comprises:
a condition monitoring control board which monitors and controls condition of the water supply pump, the sample supply pump and the sample extraction pump; and
a power supply unit electrically connected to the condition monitoring control board to supply power to the condition monitoring control board.

4. The wet cyclone apparatus according to claim 3, wherein the condition monitoring control board is equipped with a wireless communication unit to remotely enable condition monitoring and control.

5. The wet cyclone apparatus according to claim 1, wherein the inlet filters out fine dust and airborne microorganism particles from coarse particles to separate and concentrate target particles.

6. The wet cyclone apparatus according to claim 1, further comprising:
a sample extraction pump which provides a pumping power to extract the collected wetted samples in the wet cyclone; and
a sample storage which stores the extracted samples.

7. The wet cyclone apparatus according to claim 1, wherein inner walls of the wet cyclone are treated with superhydrophilic coating to improve collection performance.

8. The wet cyclone apparatus according to claim 1, wherein the wet cyclone is transparent to see changes at interface between gas and liquid and concentrated wetted particles with a naked eye.

9. The wet cyclone apparatus according to claim 1, wherein two or more water inlets are arranged along a circumferential direction from an outer periphery of a body of the wet cyclone.
